(19) United States
(12) Patent Application Publication
(10) Pub. No.: US 2011/0131094 A1
(43) Pub. Date: Jun. 2, 2011

(54) Adding and Displaying an Advertisement Content in an Electronic Book Method and Apparatus Thereof

(75) Inventors: Kai-Cheng Chuang, Tainan City (TW); Tzu-Ming Wang, Fengshan City (TW); Po-Wen Hsiao, Hsinchu City (TW); Gwo-Feng Hwang, Zhudong Township (TW)

(73) Assignee: PRIME VIEW INTERNATIONAL CO., LTD., Hsinchu (TW)

(21) Appl. No.: 12/683,136

(22) Filed: Jan. 6, 2010

(30) Foreign Application Priority Data
Dec. 2, 2009 (TW) 98141231

(51) Int. Cl. G06Q 30/00; G06Q 50/00; G06F 3/048

(52) U.S. Cl. 705/14.61; 705/14.49; 715/776

(57) ABSTRACT

This invention discloses a method to add and display an advertisement content in an electronic book. The method comprises the following steps. First, a content of a book and a content of an advertisement is provided. Next, the content of the book and the content of the advertisement are digitalized to form an electronic book. Then, an order to advertise the content of the advertisement is set. Finally, a displaying condition is set for displaying the content of the advertisement when the electronic book is read in an electronic paper display.

### RELATED APPLICATIONS

This application claims priority to Taiwan Application Serial Number 98141231, filed Dec. 2, 2009, which is herein incorporated by reference.

### BACKGROUND

1. Field of Invention

The present invention relates to an advertising method. More particularly, the present invention relates to an advertising method in an electronic paper display.

2. Description of Related Art

Digital paper displays are being developed as next generation display devices, succeeding liquid crystal displays (LCD), plasma display panels (PDP), and electronic paper display. In particular, electronic paper display is a display device in which letters or images are transformed to digital form and displayed. That is, the content of the paper book can be digitalized to display in the electronic paper display. The electronic paper display can be re-used several million times. The electronic paper has gradually replaced the paper book to become the reading medium.

Therefore, it is a destination for the engineer to process an advertisement in the new reading medium.

### SUMMARY

This invention discloses a method to add and display an advertisement content in an electronic book. The method comprises the following steps. First, a content of a book and a content of an advertisement is provided. Next, the content of the book and the content of the advertisement are digitalized to form an electronic book. Then, an order to advertise the content of the advertisement is set. Finally, a displaying condition is set for displaying the content of the advertisement when the electronic book is reading in an electronic paper display.

In an embodiment, the content of the advertisement includes a plurality of different advertisements. When the content of the book is related to the content of the advertisement, connection relationship between pages of the electronic book and the advertisement is set. When a page has been set to connect with an advertisement, this advertisement is displayed in the electronic paper display when the page is displayed in the electronic paper display over the special time period

In another embodiment, the content of the advertisement includes a plurality of different advertisements. When the content of the book is not related to the content of the advertisement, a display order for displaying the advertisement is set. When one page of the electronic book is displayed in the electronic paper display over the special time period, the content of the advertisement that is in the display order is displayed in the electronic paper display.

This invention also discloses a display system to display an electronic book. The system includes a display element, a memory element storing the electronic book, wherein the electronic book includes a digital advertisement content and a digital book content, a counter for counting a time period and determining whether or not the time period satisfies a set time to send a first control signal or a second control signal, and a display control element for receiving the first control signal or the second control signal to control the display element to display the digital advertisement content or the digital book content.

In an embodiment, when the digital book content is related to the plurality of different advertisements, connection relationship exists between pages of the digital book content and the plurality of different advertisements respectively. When a page of the digital book content has a connection relationship with an advertisement, this display element displays the advertisement when the page is displayed in the electronic paper display over the set time.

In another embodiment, when the digital book content is not related to the plurality of different advertisements, a display order exists among the plurality of different advertisements. When one page of the digital book content is displayed in the electronic paper display over the set time, this display element displays the advertisement based on the display order.

As aforementioned, the invention provides the following advantages. Because the electronic paper display almost does not consume any power when same image is displayed, the advertisement can be kept in the display continuously. When a reader reads the electronic book again, the reader is forced to see the advertisement first. Therefore, an advertisement effect is reached. Moreover, the advertisement is displayed only when the electronic paper display is in an idle state. Therefore, the reader is not disturbed by the advertisement.

### BRIEF DESCRIPTION OF THE DRAWINGS

The invention can be more fully understood by reading the following detailed description of the embodiment, with reference made to the accompanying drawings as follows:

FIG. 1 illustrates a schematic diagram of an electronic paper display.

FIG. 2 illustrates a flowchart to form an electronic book having advertisement content.

FIG. 3 illustrates a flowchart to display advertisement in the electronic paper display.

FIG. 4 illustrates a schematic diagram of an electronic paper display used in the present invention.

### DETAILED DESCRIPTION

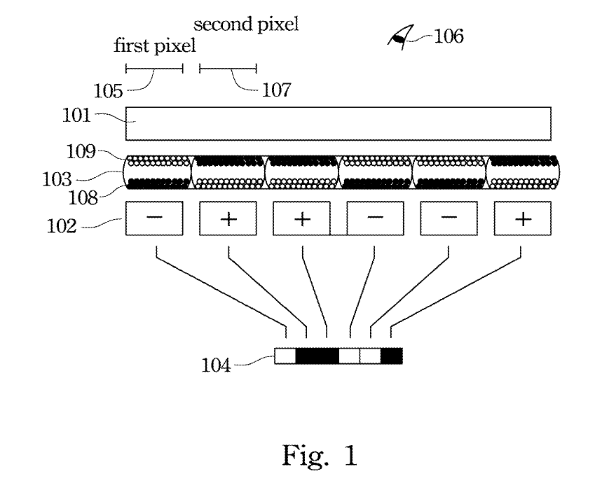

FIG. 1 illustrates a schematic diagram of an electronic paper display. The electronic paper display includes two glass substrates 101 and 102 and an electronic ink layer 103 located between the two glass substrates 101 and 102. A common electrode is formed over the glass substrate 101. A plurality of electrode is formed in the glass substrate 102. The glass substrates 101 and 102 can be replaced by plastic substrates. The electronic ink layer 103 includes a plurality of microcapsules whose diameter is about 50 micrometer-70 micrometer. Each microcapsules includes black particles 108 and white particles 109. When the electrodes in the glass substrate 102 are charged, the charged electrodes can move up or down the black particles 108 and white particles 109 to display a black-white image in the visual side 106.

For example, a white-black-black-white-white-black display 104 is displayed. The black particles 108 are positive electrical charged and the white particles 109 are negative electrical charged. Accordingly, in the first pixel 105, a white color image is displayed in the visual side 106. Therefore, an electrode in the first pixel 105 in the glass substrate 102 is charged to form a negative electrode to absorb the positive electrical charged black particles 108 and repulse the negative electrical charged white particles 109. That is, the white particles 109 are arranged in the visual side 106 to display white color. In the second pixel 107, a black color image is displayed in the visual side 106. Therefore, an electrode in the first pixel 105 in the glass substrate 102 is charged to form a positive electrode to absorb the negative electrical charged white particles 109 and repulse the positive electrical charged black particles 108. That is, the black particles 108 are arranged in the visual side 106 to display black color. The rest may be deduced by analogy.

Accordingly, the electronic paper display can reflect the environment light. Therefore, it is not necessary for the electronic paper display to use the back light source. Moreover, an Electrophoretic principle is used in the electronic paper display to display the black-white image. Therefore, the electronic paper display has a bistable characteristic. That is, the electrodes in the glass substrate 102 are charged only when the image is refreshed. In other words, when the image is not refreshed, it is not necessary to charge the electrodes in the glass substrate 102. Therefore, the electronic paper display almost does not consume any power when a same image is displayed.

The method uses the bistable characteristic to display an advertisement in the electronic paper display. When a reader does not read an electronic book displayed in the electronic paper display, a corresponding advertisement is displayed. Because the electronic paper display almost does not consume any power when same image is displayed, the advertisement can be kept in the display continuously. When a reader reads the electronic book again, the reader is forced to see the advertisement first. Therefore, an advertisement effect is reached. In another embodiment, the advertisement method can be used in other displays with bistable characteristic, such as Electrophoretic Displays, Cholesteric Displays, MEMS displays, electrowetting displays and so on.

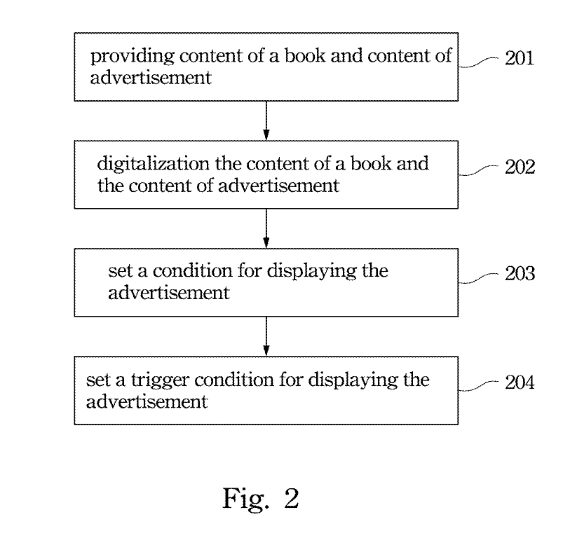

FIG. 2 illustrates a flowchart to form an electronic book having advertisement content. First, in step 201, the content of a book and the content of the advertisement is provided. The content of the advertisement is provided by an advertiser. The content of the book is provided by a publisher. The content of the advertisement can be related to the content of the book. In another embodiment, the content of the advertisement and the content of the book are independent.

Next, in step 202, the content of the book and the advertisement are digitalized and are integrated together to form an electronic book. In an embodiment, the electronic book has a format that can be displayed by the electronic paper display, such as ePub format, PDF format or TXT format.

In step 203, a condition for displaying the advertisement is set. In an embodiment, when the content of the advertisement is related to the content of the book, a connecting relationship between the page of the book and the advertisement is set during digitalizing process. For example, a connecting relationship between the fourth page of the book and the advertisement is set. Accordingly, when a reader stops reading the electronic book and the fourth page that is the last page read by the reader, the advertisement that is set to connect with the fourth page of the electronic book is displayed in the electronic paper display.

In another embodiment, when the content of the advertisement is not related to the content of the electronic book, an advertisement display order is set during digitalizing process. Accordingly, when a reader stops reading the electronic book, the advertisement that is in order is displayed in the electronic paper display.

In another embodiment, when partial content of the advertisement is related to the content of the electronic book and another content of the advertisement is not related to the content of the electronic book, a connecting relationship between the page of the electronic book and the advertisement and an advertisement display order are set together. Accordingly, when a reader stops reading the electronic book and the fourth page that is the last page read by the reader, if a connection relationship with an advertisement is set in the fourth page, this advertisement is displayed in the electronic paper display. On the other hand, if there is no connection relationship with an advertisement set in the fourth page, the advertisement that is in order is displayed in the electronic paper display.

In step 204, a trigger condition for displaying advertisement is set. This condition is an idle time of the electronic paper display. In an embodiment, the idle time is 20 minutes. That is, when a same page of the electronic book is displayed in the electronic paper display for 20 minutes, the electronic paper display will display a corresponding advertisement that is set in step 203. Finally, the finished electronic book can be sold in the market.

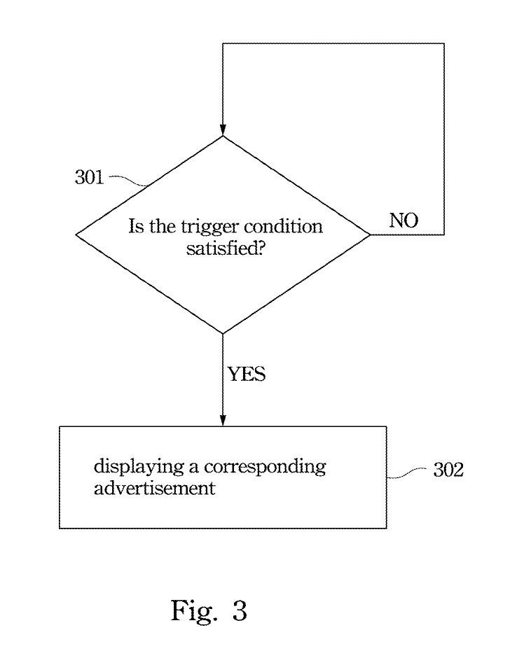

When a reader buys this electronic book with advertisement and loads this electronic book in an electronic paper display, when the electronic paper display is idled to a set time period, a corresponding advertisement is displayed in the electronic paper display. FIG. 3 illustrates a flowchart to display advertisement in the electronic paper display. In step 301, a determination process is performed to determine whether or not the trigger condition is satisfied. In an embodiment, the trigger condition is the electronic paper display is idled to 20 minutes. That is, when a same page of the electronic book is displayed in the electronic paper display for 20 minutes, the electronic paper display will display a corresponding advertisement in step 302. Which advertisement should be displayed depends on a set condition. For example, when a special page has been set to connect with an advertisement, this advertisement is displayed in the electronic paper display when the special page is displayed in the electronic paper display for 20 minutes. When the special page is not set to connect with any advertisement, the advertisement that is in order is displayed in the electronic paper display when the special page is displayed in the electronic paper display for 20 minutes. On the other hand, when the trigger condition is not satisfied in step 301, no advertisement is displayed.

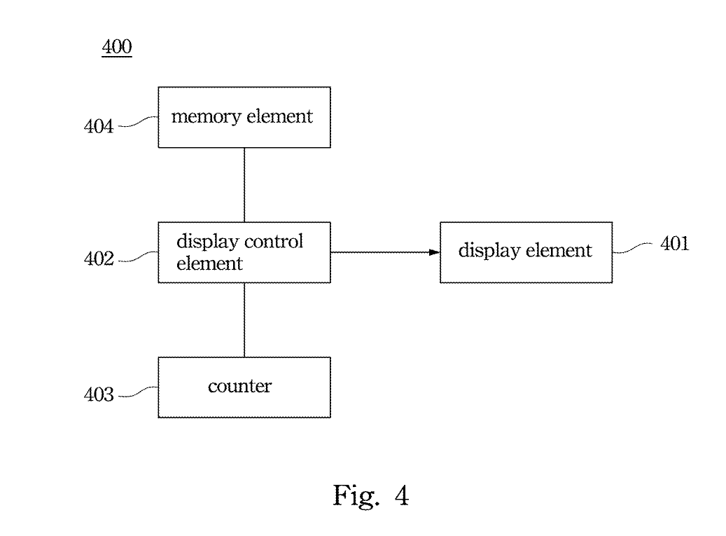

FIG. 4 illustrates a schematic diagram of an electronic paper display used in the present invention. The electronic paper display 400 includes a display element 401, a display control element 402, a counter 403 and a memory element 404. The memory element 404 stores at least one electronic book with the content of advertisement and the content of book. The counter 403 counts a time period and determines whether or not the time period satisfies a set time. The counter 403 can send a first control signal and a second control signal based on the determination. The display control element 402 can receive the first control signal or the second control signal to control the display element to display the content of advertisement or the content of book. The display control element 402, for example, is a CPU of the electronic paper display.

In an embodiment, the set time is an idle time of the electronic paper display. For example, the idle time is 20 minutes. That is, when the counter 403 counts a same page of the electronic book being displayed in the electronic paper display for 20 minutes, the counter 403 sends a second control signal to the display control element 402 to display the content of a corresponding advertisement. When a special page has been set to connect with an advertisement, this advertisement is displayed in the electronic paper display when the special page is displayed in the electronic paper display for 20 minutes. When the special page is not set to connect with any advertisement, the advertisement that is in order is displayed in the electronic paper display when the special page is displayed in the electronic paper display for 20 minutes. On the other hand, when the counter 403 counts a same page of the electronic book not being displayed in the electronic paper display for 20 minutes, the counter 403 sends a first control signal to the display control element 402 to display the content of book.

The invention can provide the following advantages. Because the electronic paper display almost does not consume any power when same image is displayed, the advertisement can be kept in the display continuously. When a reader reads the electronic book again, the reader is forced to see the advertisement first. Therefore, an advertisement effect is reached. Moreover, the advertisement is displayed only when the electronic paper display is in an idle state. Therefore, the reader is not disturbed by the advertisement.

Although the present invention has been described in considerable detail with reference to certain embodiments thereof, other embodiments are possible. Therefore, it will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method to add and display an advertisement content in an electronic book, comprising:
providing a content of a book and a content of an advertisement;
digitalizing the content of the book and the content of the advertisement to form an electronic book;
setting an order to advertise the content of the advertisement; and
setting a displaying condition for displaying the content of the advertisement when the electronic book is read in an electronic paper display.

2. The method of claim 1, wherein the displaying condition is that one page of the electronic book is displayed in the electronic paper display over a special time period when the electronic book is read.

3. The method of claim 2, wherein the content of the advertisement includes a plurality of different advertisements.

4. The method of claim 3, wherein setting an order to advertise the content of the advertisement, further comprising to set connection relationship between pages of the electronic book and the advertisement when the content of the book is related to the content of the advertisement.

5. The method of claim 4, further comprises when a page has been set to connect with an advertisement, this advertisement is displayed in the electronic paper display when the page is displayed in the electronic paper display over the special time period.

6. The method of claim 3, wherein setting an order to advertise the content of the advertisement, further comprising to set a display order for displaying the advertisement when the content of the book is not related to the content of the advertisement.

7. The method of claim 6, further comprises to display the content of the advertisement that is in the display order in the electronic paper display when one page of the electronic book is displayed in the electronic paper display over the special time period.

8. A display system to display an electronic book, comprising:
a display element;
a memory element storing the electronic book, wherein the electronic book includes a digital advertisement content and a digital book content;
a counter for counting a time period and determining the time period whether or not satisfies a set time to send a first control signal or a second control signal; and
a display control element for receiving the first control signal or the second control signal to control the display element to display the digital advertisement content or the digital book content.

9. The display system of claim 8, wherein the set time is that one page of the electronic book is displayed in the electronic paper display over a special time period when the electronic book is read.

10. The display system of claim 9, wherein the digital advertisement content includes a plurality of different advertisements.

11. The display system of claim 10, wherein when the digital book content is related to the plurality of different advertisements, connection relationship exists between pages of the digital book content and the plurality of different advertisements respectively.

12. The display system of claim 11, wherein when a page of the digital book content has a connection relationship with an advertisement, this display element displays the advertisement when the page is displayed in the electronic paper display over the set time.

13. The display system of claim 10, wherein when the digital book content is not related to the plurality of different advertisements, a display order exists among the plurality of different advertisements.

14. The display system of claim 13, this display element displays the advertisement based on the display order when one page of the digital book content is displayed in the electronic paper display over the set time.
